(19) United States
(12) Patent Application Publication
(10) Pub. No.: US 2013/0119799 A1
(43) Pub. Date: May 16, 2013

(54) FUEL PUMP

(71) Applicant: Aisan Kogyo Kabushiki Kaisha, Aichi-ken (JP)

(72) Inventors: Yoshihiko Honda, Aichi-ken (JP); Yoichi Kawakita, Aichi-ken (JP)

(73) Assignee: AISAN KOGYO KABUSHIKI KAISHA, Aichi-ken (JP)

(21) Appl. No.: 13/674,047

(22) Filed: Nov. 11, 2012

(30) Foreign Application Priority Data
Nov. 16, 2011 (JP) 2011-250479

(51) Int. Cl. H02K 11/00

(52) U.S. Cl. CPC H02K 11/0094
USPC 310/71

(57) ABSTRACT

A fuel pump may be configured to suck fuel into a case and discharge the fuel outside the case. The fuel pump may comprise a rotor, a bearing and a reference terminal. The rotor may be configured to be disposed within the case and include a shaft The bearing may be configured to be disposed within the ease, be made from metal and support the shaft rotatably. The reference terminal may be configured to be maintained at a specific electric potential. The bearing may be configured to electrically connect with the reference terminal. The specific electric potential may be lower than an electric potential of the bearing.

### CROSS-REFERENCE TO RELATED APPLICATIONS

This application claims priorities to Japanese Patent Application No. 2011-250479, filed on Nov. 16, 2011, the contents of which are hereby incorporated by reference into the present application.

### TECHNICAL FIELD

This specification discloses a fuel pump configured to suck fuel into a case and discharges the fuel outside the case.

### DESCRIPTION OF RELATED ART

Japanese Patent Application Publication No. H6-185425 discloses a fuel pump that sucks fuel in a fuel tank into a case and discharges the sucked fuel outside the case. In this fuel pump, positive and negative-side commutator brushes contact a rotor to supply electric current to the rotor. Each commutator brush is biased toward the rotor by a compression spring. Each compression spring is maintained at a negative electric potential and is electrically isolated from the positive-side commutator brush. In this configuration, electrolytic corrosion (i.e., ionization of metal) of all metal members on an electric current path is prevented.

### SUMMARY

In the fuel pump, a metal bearing that supports the shaft of the rotor is disposed in addition to the metal members on the electric current path. In the technique of Japanese Patent Application Publication No. H6-I85425, it is not possible to prevent ionization of the metal that constitutes the bearing which is not disposed on the electric current path. This specification provides a technique of appropriately suppressing ionization of metal that constitutes a bearing.

An art disclosed in the present application relates to a fuel pump configured to suck fuel into a case and discharge the fuel outside the case. The fuel pump may comprise a rotor, a bearing and a reference terminal. The rotor may be configured to be disposed within the case and include a shaft. The bearing may be configured to be disposed within the case, be made from metal and support the shaft rotatably. The reference terminal may be configured to be maintained at a specific electric potential. The bearing may be configured to electrically connect with the reference terminal. The specific electric potential may be lower than an electric potential of the bearing.

For example, the metal that constitutes the bearing is likely to be ionized when the metal is immersed in fuel that is oxidized and degraded. Moreover, for example, when the bearing is disposed near a member (for example, a positive-side brush that supplies electric current to a rotor) that is at a higher electric potential than the bearing, the metal that constitutes the bearing is likely to be ionized due to an electric potential difference between the bearing and the high electric potential-side member. In the above-described fuel pump, electrons are supplied to the bearing via the reference terminal. Thus, ionization of the metal that constitutes the bearing may be suppressed.

### BRIEF DESCRIPTION OF DRAWINGS

FIG. 1 is a vertical cross-sectional view of a fuel pump according to a first embodiment. FIG. 2 is a partial plan view of the fuel pump. FIG. 3 is a partial vertical cross-sectional view of a fuel pump according to a second embodiment. FIG. 4 is a partial vertical cross-sectional view of a fuel pump according to a third embodiment. FIG. 5 is a vertical cross-sectional view of a fuel pump according to a fourth embodiment. FIG. 6 is a vertical cross-sectional view of a fuel pump according to a fifth embodiment.

### DETAILED DESCRIPTION

Representative, non-limiting examples of the present invention will now be described in further detail with reference to the attached drawings. This detailed description is merely intended to teach a person of skill in the art further details for practicing preferred aspects of the present teachings and is not intended to limit the scope of the invention. Furthermore, each of the additional features and teachings disclosed below may be utilized separately or in conjunction with other features and teachings to provide improved fuel pumps, as well as methods for using and manufacturing the same.

Moreover, combinations of features and steps disclosed in the following detailed description may not be necessary to practice the invention in the broadest sense, and are instead taught merely to particularly describe representative examples of the invention. Furthermore, various features of the below-described representative examples, as well as the various independent and dependent claims, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

The fuel pump described herein may include one or more of the following features. The reference terminal may be fixed to the case and contact an edge surface of the bearing in an axial direction of the shaft. According to this configuration, the bearing may be prevented from moving in an axial direction of the shaft.

The fuel pump may further comprise a supplying terminal configured to electrically connect with the rotor and supply electric current to the rotor. The reference terminal may further electrically connect with the rotor. According to this configuration, the reference terminal may form the path for the electric current supplied to the rotor and supply electrons to the bearing. Thus, it is not necessary to separately provide a terminal that forms the path for electric current and a terminal for suppressing ionization of the metal that constitutes the bearing.

The fuel pump may further comprise a stator configured to be disposed along an outer circumference of the rotor and a plurality of supplying terminals configured to supply electric current to the stator. According to this configuration, in a fuel pump that includes a type of motor that rotates a rotor by supplying electric current to a stator, ionization of the metal that constitutes the bearing may be appropriately suppressed.

### First Embodiment

(Configuration of Fuel Pump 10)

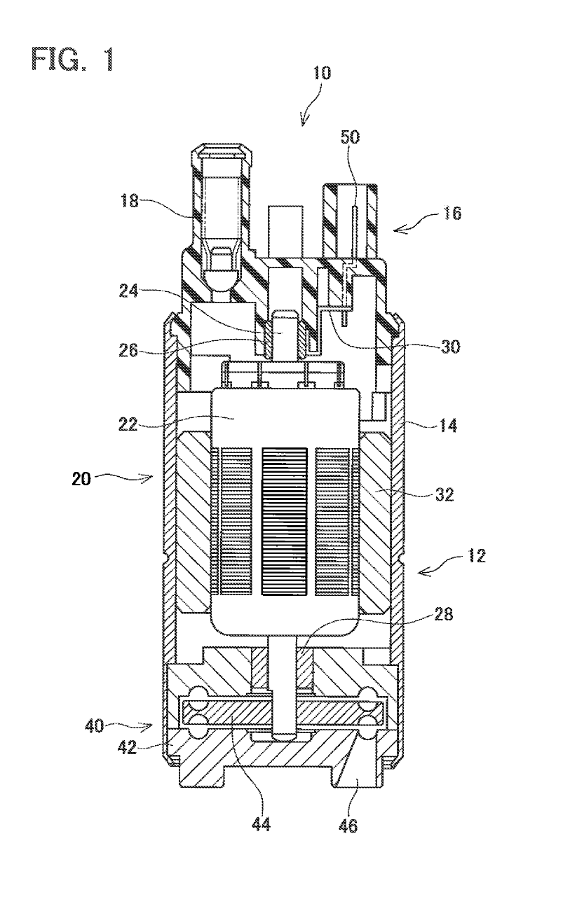

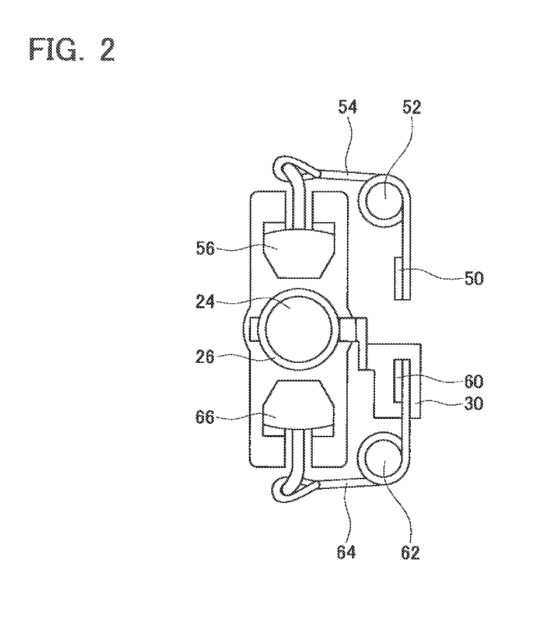

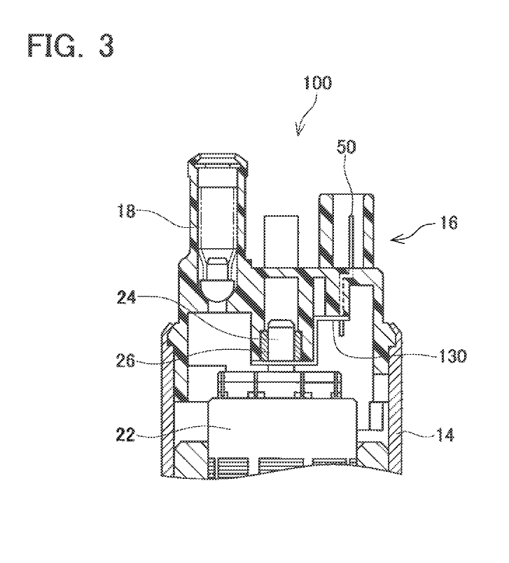

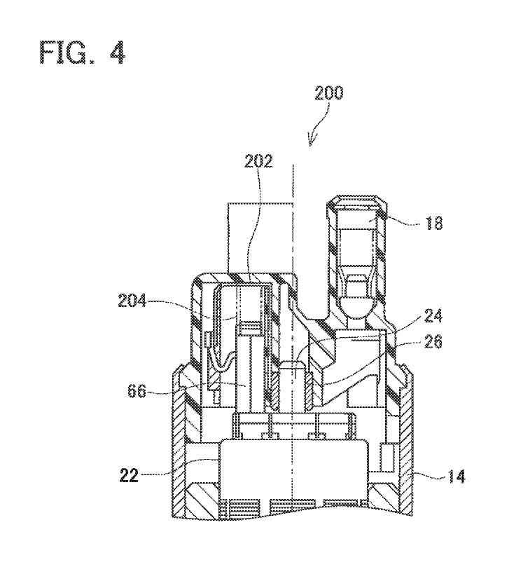

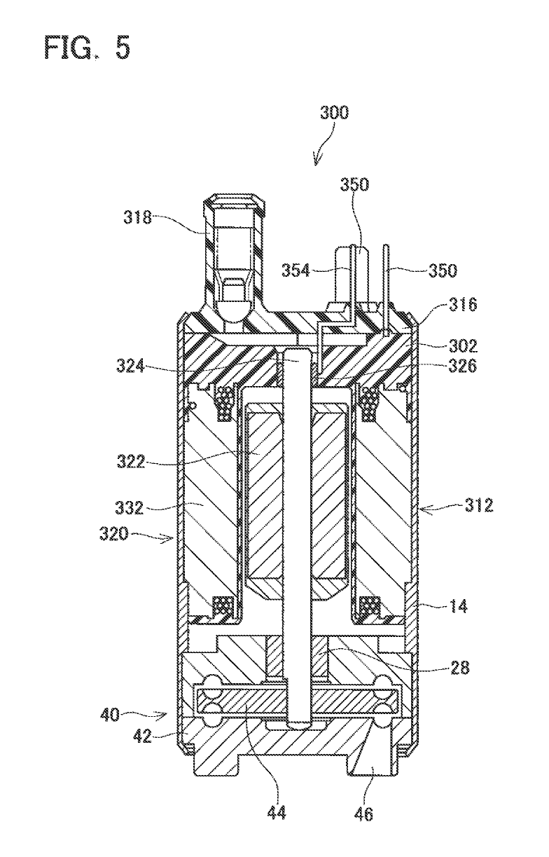

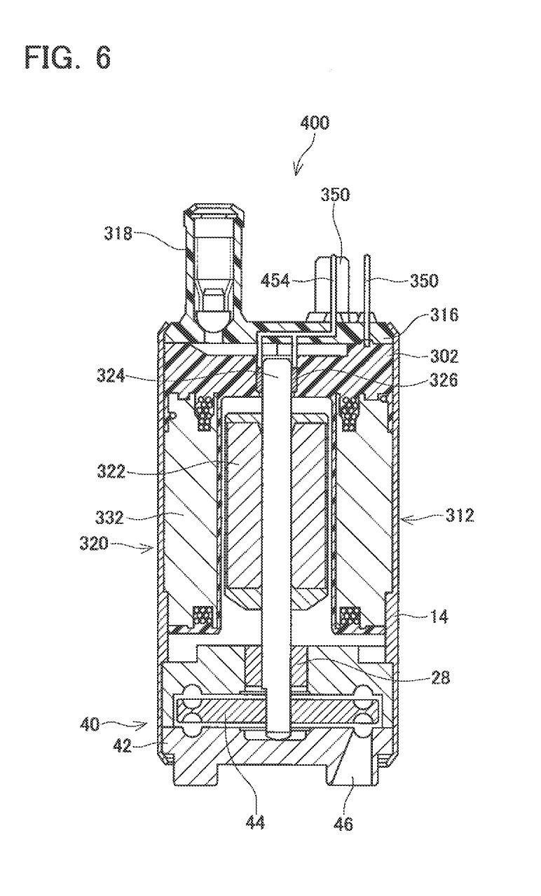

As illustrated in FIG. 1, a fuel pump 10 is disposed within a fuel tank (not illustrated) to supply fuel (for example, gasoline, blended fuel of ethanol and gasoline, or the like) to an engine (not illustrated) of an automobile. As illustrated in FIG. 1, the fuel pump 10 comprises a motor portion 20 and a pump portion 40.

The motor portion 20 and the pump portion 40 are disposed within a case 12. The case 12 comprises a cylindrical housing 14, a casing 42 (part of the pump portion 40) that closes an opening at a lower end of the housing 14, and a lid portion 16 that closes an opening at an upper end of the housing 14.

The pump portion 40 comprises the casing 42 and an impeller 44. The casing 42 is made from metal. A suction port 46 is formed at a lower end of the casing 42. A communication hole (not illustrated) that communicates with the inside of the casing 42 and the motor portion 20 is formed at an upper end of the casing 42. The impeller 44 is accommodated in the easing 42. A lower bearing 28 is fixed to the casing 42 positioned above the impeller 44.

The motor portion 20 is a brush motor. The motor portion 20 comprises a rotor 22 and a stator 32. The stator 32 is disposed along an inner circumferential surface of the housing 14. The stator 32 comprises a permanent magnet. The rotor 22 is disposed on the inner circumference side of the stator 32. A shaft 24 passes through and is fixed to a center of the rotor 22. A lower end of the shaft 24 is inserted into and passes through a central portion of the impeller 44.

The shaft 24 is rotatably held on the casing 42 at an upper end side of the pump portion 40 (i.e., a lower end side of the motor portion 20) with the lower bearing 28 interposed. The upper end of the shaft 24 is rotatably held on the lid portion 16 with an upper bearing 26 interposed. That is, the rotor 22 is rotatably held on the case 12. The upper bearing 26 and the lower bearing 28 are both made from metal, e.g., a copper alloy.

The lid portion 16 is disposed above the motor portion 20. The lid portion 16 is made from a resin. A discharge port 18, a positive terminal 50, a negative terminal 60 (see FIG. 2), and the upper bearing 26 are provided in the lid portion 16. The discharge port 18 communicates with the outside and the inside of the ease 12.

The upper bearing 26 is fitted to a recess portion that is formed near the center of the lid portion 16. More specifically, the upper bearing 26 is press-fitted, from below to above, to the recess portion having an opening under the lid portion 16.

The respective terminals 50 and 60 extend from an upper portion of the lid portion 16 (i.e., an upper portion of the case 12), pass through the lid portion 16, and reach the motor portion 20 of the case 12. The respective terminals 50 and 60 are made from a metal plate having a constant thickness. The respective terminals 50 and 60 are fixed to the lid portion 16 by insert molding. The upper end of the positive terminal 50 is connected to a battery (not illustrated) of an automobile. The upper end of the negative terminal 60 is grounded.

FIG. 2 illustrates a plan view of a part of the fuel pump 10 (i.e., a top view of FIG. 1). A conductor wire 54 extending from the positive terminal 50 is connected to a positive-side brush 56 via a choke coil 52. The lower end of the positive-side brush 56 is in contact with the rotor 22 (see FIG. 1). A conductor wire 64 extending from the negative terminal 60 is connected to a negative-side brush 66 via a choke coil 62. The lower end of the negative-side brush 66 is in contact with the rotor 22 (see FIG. 1).

A conductive connection member 30 is fixed to an intermediate portion of the negative terminal 60. The connection member 30 is made from metal such as stainless steel (e.g., SUS or the like) that has high resistance to corrosion. One end of the connection member 30 is disposed to take a round along a circumferential direction of the negative terminal 60. Thus, the negative terminal 60 and the connection member 30 are tightly fixed. The other end of the connection member 30 is press-fitted to a gap between the lid portion 16 and the upper bearing 26 and is in contact with an outer circumferential surface of the upper bearing 26 in a state of being press-fitted to the outer circumferential surface of the upper bearing 26 (see FIG. 1).

(Operation of Fuel Pump 10)

When electric current is supplied from the battery to the fuel pump 10, electric current is supplied from the positive terminal 50 to the rotor 22 via the positive-side brush 56. As a result, the rotor 22 rotates around the shaft 24. The electric current supplied to the rotor 22 reaches the negative terminal 60 via the negative-side brush 66.

The impeller 44 rotates with the rotation of the rotor 22. When the impeller 44 rotates, the fuel in the fuel tank is sucked into the casing 42 (i.e., the case 12) through the suction port 46. The fuel in the casing 42 is boosted with the rotation of the impeller 44 and passes through a communication hole to flow into the motor portion 20. The fuel flowed into the motor portion 20 passes between the rotor 22 and the stator 32 to reach an upper portion of the rotor 22. That is, when the fuel pump 10 operates, the inside of the case 12 is filled with fuel. The fuel is discharged outside the fuel pump 10 (i.e., the case 12) through the discharge port 18. The fuel discharged outside the fuel pump 10 is supplied to the engine through a fuel path (not illustrated).

### Effects of Present Embodiment

The upper bearing 26 is disposed near the positive-side brush 56. As a result, the metal, which in this embodiment is copper, that constitutes the upper bearing 26 is likely to be ionized due to an electric potential difference between the upper bearing 26 and the positive-side brush 56. Moreover, when the electric current is supplied to the fuel pump 10, the upper bearing 26 is at a higher electric potential than the negative terminal 60. In the fuel pump 10, the upper bearing 26 is connected to the negative terminal 60 via the connection member 30 and is disposed in a grounded state. As a result, electrons are supplied from the negative terminal 60 to the upper bearing 26 (i.e., the electric current flows from the upper beating 26 to the negative terminal 60), and ionization of the copper that constitutes the upper bearing 26 is suppressed. That is, it is possible to suppress electrolytic corrosion of the upper bearing 26. Moreover, in a state where fuel is oxidized and degraded, the copper that constitutes the upper bearing 26 is likely to be ionized (Le., the copper is likely to melt into the oxidized and degraded fuel). In this state, it is also possible to suppress ionization of copper.

Moreover, electrons are supplied from the negative terminal 60 to the lower bearing 28 via the connection member 30, the upper bearing 26, and the shaft 24. Thus, similar to the upper bearing 26, ionization of the copper that constitutes the lower bearing 28 is suppressed.

Moreover, in the fuel pump 10, since the upper bearing 26 is connected to the negative terminal 60 via the connection member 30, the upper bearing 26 is grounded. According to this configuration, it is not necessary to provide a dedicated terminal for grounding the upper bearing 26 in the lid portion 16. It should be noted that a configuration in which a dedicated terminal for grounding the upper bearing 26 is provided may be employed. In this case, the dedicated terminal may be not grounded. For example, the dedicated terminal may be maintained at a lower electric potential than the electric potential of the upper bearing 26 when electric current is supplied to the fuel pump 10 (i.e., during the operation of the fuel pump 10).

### Second Embodiment

As illustrated in FIG. 3, in a fuel pump 100 according to the second embodiment, the shape of a connection member 130 is different from the shape of the connection member 30 of the fuel pump 10. Since other constituent components are the same as the constituent components of the fuel pump 10, description thereof will not be provided. The connection member 130 is made from metal that has high resistance to corrosion similar to the connection member 30, and is fixed to the negative terminal 60.

An end portion of the connection member 130 closer to the upper bearing 26 is formed in a ring shape. The ring-shaped end portion of the connection member 130 is in contact with the lower end surface of the upper bearing 26. Specifically, the connection member 130 is in contact with the lower end surface of the upper bearing 26 in a state where the connection member 130 presses the upper bearing 26 upward.

The fuel pump 100 also provides the same effects as those obtained with the fuel pump 10. Further, in the fuel pump 100, the connection member 130 prevents the upper bearing 26 from dropping off from the lid portion 16.

### Third Embodiment

As illustrated in FIG. 4, in a fuel pump 200 according to the third embodiment, the structure of a connection member 202 is different from the structure of the connection member 30 of the fuel pump 10. Since other constituent components are the same as the constituent components of the fuel pump 10, description thereof will not be provided. The connection member 202 is made from metal that has high resistance to corrosion similar to the connection member 30 and is fixed to the negative terminal 60.

One end of the connection member 202 is disposed between the lid 16 and an upper end of a coil spring 204 that presses the negative-side brush 66 toward the rotor 22. The connection member 202 extends along a surface of the lid portion 16 closer to the case 12. The other end of the connection member 202 is in contact with the outer circumferential surface of the upper bearing 26. The connection member 202 is fixed to the lid portion 16 by insert molding.

The fuel pump 200 can suppress ionization of the metal (which in this embodiment is copper) that constitutes the upper bearing 26 similar to the fuel pump 10. Further, in the fuel pump 200, since the connection member 202 is fixed to the lid portion 16 during insert molding, it is not necessary to press-fit the connection member 202 into the lid portion 16 after molding the lid portion 16.

### Fourth Embodiment

(Configuration of Fuel Pump 300)

As illustrated in FIG. 5, a fuel pump 300 supplies fuel to an engine of an automobile in a manner similar to the fuel pump 10. In the fourth embodiment, the same constituent components as those of the fuel pump 10 will be denoted by the same reference numerals as those of the fuel pump 10, and description thereof will not be provided. As illustrated in FIG. 5, the fuel pump 300 comprises a motor portion 320 and the pump portion 40.

The motor portion 320 and the pump portion 40 are disposed in a case 312. The case 312 comprises the housing 14, the casing 42, and a lid portion 316 that closes an opening at an upper end of the housing 14.

The motor portion 320 is a brushless motor. The motor portion 320 comprises a rotor 322 and a stator 332. The stator 332 comprises a plurality of cores. A conductor wire is wound around each of the plurality of cores (for example, six cores). The plurality of cores is disposed to surround an inner circumferential surface of the housing 14. The stator 332 is covered by a resin layer 302. The rotor 322 comprises a permanent magnet. A shaft 324 passes through and is fixed to the center of the rotor 322. The lower end of the shaft 324 is inserted into and passes through a central portion of the impeller 44. The upper end of the shaft 324 is rotatably held on an upper bearing 326. The upper bearing 326 is press-fitted to the resin layer 302. That is, the rotor 332 is rotatably held on the ease 312.

The lid portion 316 is disposed above the motor portion 320. The lid portion 316 is formed of resin. A discharge port 318, a plurality of supplying terminals (e.g., three supplying terminals) 350, and one reference terminal 354 are provided in the lid portion 316. The discharge port 318 communicates with the outside and the inside of the case 312. The plurality of supplying terminals 350 and one reference terminal 354 are fixed to the lid portion 316 by insert molding.

Each of the plurality of supplying terminals 350 extends from an upper portion of the lid portion 316 (i.e., an upper portion of the case 312) and passes through the lid portion 316 to reach the motor portion 320 of the case 312. The upper ends of the plurality of supplying terminals 350 are connected to a battery (not illustrated) of the automobile via a brushless motor driving circuit. Each of the plurality of supplying terminals 350 is connected to a conductor wire of at least one core.

The reference terminal 354 extends from the upper portion (the upper portion of the case 312) of the lid portion 316 and passes through the lid portion 316 to reach the motor portion 320. The reference terminal 354 is fixed to the outer circumferential surface of the upper bearing 326.

(Operation of Fuel Pump 300)

When electric current is supplied from the battery to the fuel pump 300, electric current is supplied to the plurality of supplying terminals 350. Specifically, a driving circuit is disposed between the battery and the plurality of supplying terminals 350. The driving circuit supplies appropriate electric current to each of the plurality of supplying terminals 350 according to a predetermined program. In this configuration, the rotor 322 rotates around the shaft 324. When the impeller 44 rotates with the rotation of the rotor 322, the fuel in the fuel tank is sucked into the casing 42 (i.e., the case 312) through the suction port 46 and discharged outside the fuel pump 300 (i.e., the ease 312) through the discharge port 318.

According to the configuration of the fuel pump 300, it is possible to prevent ionization of the metal (which in this embodiment is copper) that constitutes the upper hearing 326 similar to the fuel pump 10.

### Fifth Embodiment

As illustrated in FIG. 6, in a fuel pump 400 according to the fifth embodiment, the shape of a reference terminal 454 is different from the shape of the reference terminal 354 of the fuel pump 300. Since other constituent components are the same as the constituent components of the fuel pump 300, description thereof will not be provided.

A lower end of the reference terminal 454 (i.e., an end closer to the case 312) has a cylindrical shape. The other shape is the same as that of the reference terminal 354.

The reference terminal 454 is in contact with an upper end surface of the upper bearing 326. Specifically, the reference terminal 454 is in contact with the upper end surface of the upper bearing 326 in a state where the upper bearing 326 is pressed downward. Moreover, the lower end of the upper bearing 326 is supported by the resin layer 302.

The fuel pump 400 also provides the same effects as those obtained with the fuel pump 10. Further, in the fuel pump 400, the reference terminal 454 prevents the upper bearing 326 from moving upward. Moreover, the lower end of the upper bearing 326 is supported by the resin layer 302.

In the respective embodiments described above, only the upper bearing 26 or 326 is directly connected to a terminal (the negative terminal 60 or the like) that is grounded. However, the lower bearing 28 may be directly connected to the grounded terminal. According to this configuration, it is possible to appropriately prevent ionization of the metal (which in this embodiment is copper) that constitutes the lower bearing 28.

1. A fuel pump configured to suck fuel into a case and discharge the fuel outside the case, the fuel pump comprising:
a rotor configured to be disposed within the case and include a shaft;
a bearing configured to be disposed within the case, be made from metal and support the shaft rotatably; and
a reference terminal configured to be maintained at a specific electric potential, wherein
the bearing is configured to electrically connect with the reference terminal, and
the specific electric potential is lower than an electric potential of the bearing.

2. The fuel pump as in claim 1, wherein
the reference terminal is fixed to the case and contacts an edge surface of the bearing in an axial direction of the shaft.

3. The fuel pump as in claim 1, further comprising:
a supplying terminal configured to electrically connect with the rotor and supply electric current to the rotor,
wherein the reference terminal further electrically connects with the rotor.

4. The fuel pump as in claim 1, further comprising:
a stator configured to be disposed along an outer circumference of the rotor; and
a plurality of supplying terminals configured to supply electric current to the stator.
